(19) United States
(12) Patent Application Publication
(10) Pub. No.: US 2024/0066434 A1
(43) Pub. Date: Feb. 29, 2024

(54) SURFACE CARBON CAPTURE AND STORAGE

(71) Applicant: SAUDI ARABIAN OIL COMPANY, Dhahran (SA)

(72) Inventors: Abdulaziz S. Al-Qasim, Dammam (SA); Yuguo Wang, Dhahran (SA); Christopher De Grano Padilla, Dhahran (SA)

(73) Assignee: SAUDI ARABIAN OIL COMPANY, Dhahran (SA)

(21) Appl. No.: 17/823,195

(22) Filed: Aug. 30, 2022

(51) Int. Cl. B01D 19/00; C10G 31/09

(52) U.S. Cl. CPC B01D 19/0031; C10G 31/09; B01D 2221/04; C10G 2300/1033; C10G 2300/207

(57) ABSTRACT

A illustrative surface carbon capture and storage system includes a treatment and separation facility that receives CO2 containing fluid and extracts CO2 from the CO2 containing fluid. A compressor downstream of the treatment and separation facility compresses the extracted CO2 into compressed CO2, which is introduced further downstream to a reaction container along with water, and other reactants. A method for surface carbon capture and storage includes separating CO2 from a CO2 containing fluid and compressing the separated CO2. The compressed CO2, along with water, and other reactants is introduced into a reaction container where the CO2 mineralizes. The mineralized CO2 is outputted from the reaction container.

### BACKGROUND

Increased emissions of greenhouse gases are a concern because they cause global climate change. Climate change may have an impact on the ecosystem of the Earth. The role of carbon dioxide (CO2) in global climate change is of particular interest. CO2 is classified as a greenhouse gas.

Effort to eliminate and recapture CO2 emissions includes surface carbon capture and storage (SCCS) technologies, such as sequestering CO2 in basalt formations and in depleted oil and gas reservoirs.

### SUMMARY

In one aspect, embodiments disclosed herein relate to a surface carbon capture and storage system that includes a treatment and separation facility that receives CO2 containing fluid and extracts CO2 from the CO2 containing fluid. A compressor downstream of the treatment and separation facility compresses the extracted CO2 into compressed CO2 that is introduced further downstream to a reaction container along with water, and other reactants.

The surface carbon capture and storage system may be coupled downstream of a fracking system that provides the CO2 containing fluid from a subsurface injection formation. The surface carbon capture and storage system may also include an electrolyzer and an absorption cooling unit that receives byproducts of mineralization from the reaction container.

The reaction container may contain a fluid comprising basalt particles and may be coated with basaltic particles. Further, the interior surface of the reaction container may include separate compartments that may be removable.

In another aspect, embodiments disclosed herein relate to a method for surface carbon capture and storage. This method may include separating CO2 from a CO2 containing fluid and compressing the separated CO2. The compressed CO2, along with water, and a reactant may be introduced into a reaction container where the CO2 mineralizes. The mineralized CO2 may be outputted from the reaction container and may be stored.

Other aspects and advantages will be apparent from the following Detailed Description and the appended Claims.

### BRIEF DESCRIPTION OF DRAWINGS

FIG. 1 is a diagram of a surface carbon capture system according to one or more embodiments.

FIG. 2 illustrates a diagram of the reaction container in accordance with one or more embodiments.

FIG. 3 illustrates a diagram of the reaction container in accordance with one or more embodiments.

FIG. 4 illustrates a method according to one or more embodiments.

### DETAILED DESCRIPTION

Some CO2 sequestration methods involve injecting CO2 into subsurface basaltic formations where the CO2 may eventually mineralize. In conventional basaltic sequestration methods, an adequate basaltic formation for CO2 sequestration must be found—not all basalt formations are configured to accept CO2. For example, the basaltic formation must be porous enough to allow for fluid injection. Some basaltic formations may be far away from the CO2 source; therefore, the CO2 may require transportation over long distances. However, steel components may often break down from corrosion due to CO2 when CO2 is exposed to any amount of water under pressure and forms carbonic acid. Additionally, introducing CO2 into subsurface formations carries a risk of CO2 leaking to the surface environment through permeable layers, fractures, fissures, and even the wellbore. A subsurface mineralization process may take over a year. During the period of mineralization, the surface must be continuously monitored for CO2 leakage. By introducing CO2 into the subsurface environment, any useful reaction byproducts made by the CO2 may be trapped in the sequestering formation and unrecoverable.

Methods and apparatuses disclosed herein provide a way for CO2 to be captured at the surface rather than injecting the CO2 into a subsurface formation. According to embodiments of the present disclosure, a surface carbon capture and storage (SCCS) method using a reaction container apparatus is proposed for surface carbon capture and storage. The proposed reaction container may receive CO2 and other reactants involved in a surface-based CO2 mineralization process. The CO2 mineralization process, instead of occurring underground, occurs on the surface in a controlled chemical process. The products of the reactions transform CO2 gas into carbonate minerals, which are solids, thereby eliminating the CO2 gas. Useful byproducts of CO2 mineralization process may be utilized for commercial uses.

Various illustrative embodiments of the disclosed subject matter are described. In the interest of clarity, not all features of an actual implementation are described in this specification. It will of course be appreciated that in the development of any such actual embodiment, numerous implementation-specific decisions must be made to achieve the specific goals of the developers, such as compliance with system-related and business-related constraints, which will vary from one implementation to another. Moreover, it will be appreciated that such a development effort might be complex and time-consuming but may be a routine undertaking for those of ordinary skill in the art having the benefit of this disclosure.

The present subject matter will now be described with reference to the attached figures Various structures, systems, and devices are schematically depicted in the drawings for purposes of explanation only and to not obscure the present disclosure with details that are well known to those skilled in the art. Nevertheless, the attached drawings are included to describe and explain illustrative examples of the present disclosure. The words and phrases used should be understood and interpreted to have a meaning consistent with the understanding of those words and phrases by those skilled in the relevant art. No special definition of a term or phrase, that is, a definition that is different from the ordinary and customary meaning as understood by those skilled in the art, is intended to be implied by consistent usage of the term or phrase. To the extent that a term or phrase is intended to have a special meaning, that is, a meaning other than that understood by skilled artisans, such a special definition will be expressly set forth in the specification in a definitional manner that directly and unequivocally provides the special definition for the term or phrase. With reference to the attached figures, various illustrative embodiments of the systems, devices and method disclosed herein will now be described in more detail.

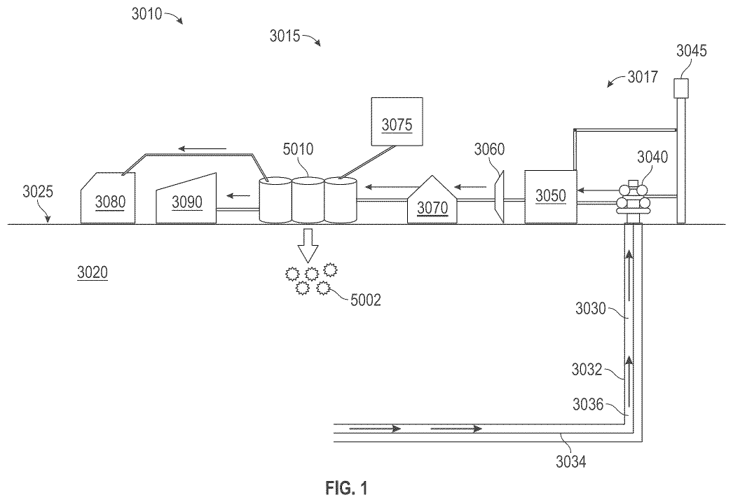

According to embodiments of the present disclosure, a SCCS system may be provided at a reservoir environment for capturing and storing CO2 gas. For example, FIG. 1 shows a diagram of a reservoir environment according to one or more embodiments. In FIG. 1, reservoir environment 3010 includes SCCS system 3015 and fracking system 3017. SCCS system 3015 is coupled to fracking system 3017. The SCCS system 3015 may be coupled downstream of the fracking system 3017.

The reservoir environment 3010 includes surface 3025, representing the surface of the earth, and a subsurface 3020 below the surface 3025. Subsurface 3020 has a well 3030 traversing through it in a generally downward direction. The well 3030 is defined by a well wall 3032 (e.g., either a cased well wall or an uncased wellbore wall) and is a void that has been drilled through the subsurface 3020. Fluid and gas communication is operable between the surface 3025 and the subsurface 3020 via well 3030, as will be further described.

The fracking system 3017 includes a wellhead 3040 that provides surface access to an injection line 3034 through the well 3030. The injection line 3034 may include drill pipe, coiled tubing, fixed tubing, or other forms of fluid conduit for conveying fluids between the surface 3025 and the subsurface 3020. The wellbore annulus 3036 is the void of the injection well 3030 between the injection line 3034 and the well wall 3032. Fracking fluid comprising CO2 may be injected into the subsurface 3020 through the injection line 3034 for fracking operations for purposes that are appreciated in the art.

After fracking operations, the fracking fluid containing CO2 (also known as “flowback fluid”) flows uphole (arrows) through the wellbore annulus 3036 to the surface 3025. CO2 in flowback fluid may be present in a gaseous or supercritical state. The flowback fluid may be directed from the wellhead 3040 and into a treatment and separation system. The treatment separation system may include a treatment and separation facility 3050, which may include one or more separation equipment units, such as a gas/liquid separator, a scrubber, etc. Flowback fluid may be directed from the wellhead 3040 to the treatment and separation facility 3050 through a flow line fluidly connecting the wellhead 3040 to the treatment and separation facility 3050. The CO2 in the flowback fluid may be separated from other substances in the flowback fluid at the treatment and separation facility 3050. In one or more embodiments, a treatment and separation facility for the flowback fluid may be a mobile facility and may be located near the wellhead 3040. In one or more embodiments, a portion of the flowback fluid passes to a flare 3045 from the wellhead 3040 via a flowline and is flared.

In some embodiments, a treatment and separation system may further contain a water (H2O) scrubber to wash CO2 and remove less soluble gasses, such as hydrogen (H2), nitrogen (N2), and methane (CH4). In one or more embodiments, CO2 is absorbed, and the non-absorbed gases may be vented or may pass to a flare 3045 from the treatment and separation facility 3050 via a flowline and are flared.

Optionally, a separation membrane 3060 may be used to further separate CO2 from other light hydrocarbons. For example, according to some embodiments of the present disclosure, a gas mixture separated from one or more separation equipment units in a treatment and separation facility 3050 may be directed to a separation membrane 3060 to separate CO2 gas from other light hydrocarbon gases. Light hydrocarbons contain approximately one to three carbon atoms per molecule, such as methane, ethane, and propane. In one or more embodiments, the separation membrane 3060 may be part of the treatment and separation system and may be located at a treatment and separation facility 3050 or may be separate from but fluidly connected to a treatment and separation facility 3050. In one or more embodiments, the light hydrocarbons separated by the separation membrane 3060 are retentate and may be passed to flare 3045 or stored for use as fuel.

After separation, CO2 may be directed into a compressor 3070 via a dedicated flowline where CO2 is compressed and pressurized to form compressed CO2 that may be a liquid, critical, or supercritical fluid. The compressor may be downstream of the treatment and separation facility according to one or more embodiments. The compressed CO2 may pass via a fluid conduit from the compressor 3070 to a reaction container 5010. Water may also be supplied to the reaction container 5010 via a fluid conduit from a water tank 3075. The CO2 and H2O may be introduced into the reaction container concurrently or separately. According to one or more embodiments, the molar ratio of water to CO2 introduced into the reaction container may be about 1:1.

In the reaction container 5010, CO2 may be reacted with water (e.g., sea water, brine, etc.) to produce byproducts for mineralization and solidification storage. Reactions for mineralization of CO2 are discussed in more detail below. In one or more embodiments, some byproducts of the CO2 mineralization reactions may pass to a byproduct unit 3080 for processing, separation, and capture. In one or more embodiments, some byproducts may be passed to an electrolyzer 3090 for processing and capture. Mineralized carbon 5002 from CO2 mineralization may be removed from the reaction container and may be stored in subsurface 3020 or surface 3025 locations. In one or more embodiments, mineralized carbon 5002 may be stored in the same wellbore that was used in the fracking operations.

While CO2 captured from a fracking operation is shown in FIG. 1, those skilled in the art would appreciate that that CO2 may be captured from several sources, including fracking operations, oil refineries, natural gas production process, and other industrial sites. Additionally, those skilled in the art would appreciate that various components of the system including, but not limited to the compressor, water tank, reaction container, and treatment and separation facility may be mobile and may be located near the wellhead 3040.

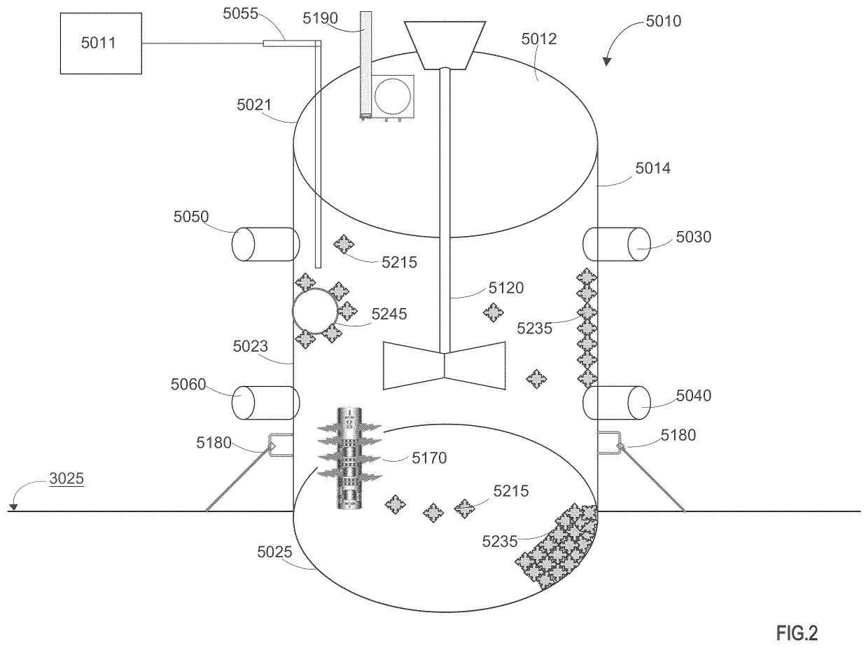

FIG. 2 is an illustration of a reaction container according to one or more embodiments. A reaction container 5010 may be used for CO2 mineralization. The reaction container 5010 may be located on the surface 3025.

The reaction container 5010 may comprise an interior surface 5012 and an exterior surface 5014. The interior surface 5012 encloses an interior chamber that is a void. The reaction container also includes a top portion 5021, a middle portion 5023, and a bottom portion 5025. In some embodiments, the top portion 5021 may be a lid, the bottom portion 5025 may be a base, and the middle portion 5023 may include a sidewall extending between the lid and the base. According to embodiments of the present disclosure, a reaction container may be made from non-metallic, corrosion-resistant materials such as chloro-sulfonated polyethylene (CSM), vulcanizates of CSM, and polyvinyl chloride (PVC), for example. Additionally, as described more below, portions of or the entire reaction container may be inflatable. In such embodiments, the reaction container may be transported in a deflated state and inflated for use. According to one or more embodiments, the dimensions of a reaction container may be about 4.0 meters in diameter and from about 4.0 meters to 6.0 meters in height. In some embodiments, a reaction container may be larger.

In one or more embodiments, a reaction container 5010 in use may be positioned vertically, e.g., where the exterior surface 5014 of the bottom portion 5025 of the reaction container may be in contact with the surface 3025 or a support structure. However, in other embodiments a reaction container 5010 in use may be positioned horizontally, e.g., where the exterior surface 5014 of the middle portion 5023 of the reaction container may be in contact with the surface 3025 or a support structure. In some embodiments, a reaction container 5010 may be positioned semi-vertically (at an angle from a vertical orientation) during operation.

According to one or more embodiments, the exterior surface 5014 of the reaction container 5010 may include anchoring systems 5180 configured to prevent the reaction container from sliding or overturning by lateral forces during use or transportation. The anchoring system may include, but is not limited to, bolts or straps. Those having skill in the art will appreciate that several types of anchoring systems may be used. The anchoring system may connect a reaction container to another reaction container, a support structure, or to the surface 3025.

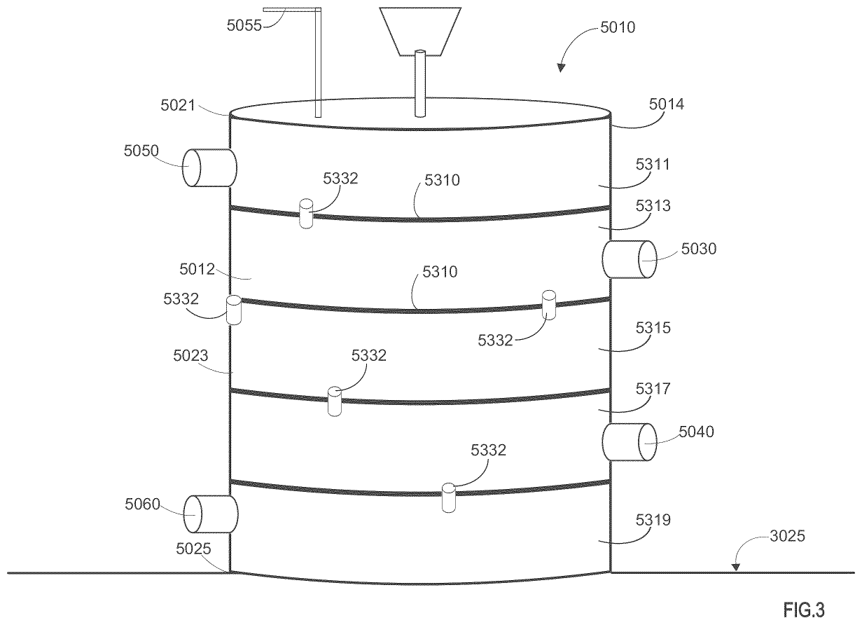

FIG. 3 is an illustration of a reaction container 5010 according to one or more embodiments where the interior surface 5012 of the reaction container may be subdivided into two or more reaction modules or compartments. Horizontal walls 5310 or plates attached to the interior surface 5012 of the reaction container may be used to subdivide the reaction container. The reaction container 5010 in FIG. 3 is an example embodiment that includes a first compartment 5311, a second compartment 5313, a third compartment 5315, a fourth compartment 5317 and a fifth compartment 5319. However, other amounts of compartments may be assembled together to form a modularized reaction container. The first compartment 5311 may form the top portion 5021 of the reaction container, and the fifth compartment may form the bottom portion 5025. The second, third, and fourth compartments 5313, 5315, 5317 may form the middle portion 5023 of the reaction container 5010.

The compartments of the reaction container 5010 may include one or more passages 5332 to pass fluids including reactants and products between compartments. The inlets may have valves to control the volume of fluid. Those having skill in the art would appreciate that the passages 5332 may be located on different parts of the reaction container including between the horizontal walls 5310 in the interior surface 5012 or along the exterior surface of the reaction container. The reaction container 5010 may include one or more inlets 5040, 5050 and one or more outlets 5030, 5055, 5060 to receive and dispense fluids, respectively, into and out of the reaction container 5010. The inlets may be connected to flowlines and may have valves to control the volume of incoming fluid. Inlet(s) or outlet(s) may be located on the same compartment or on different compartments of the reaction container. In reaction containers without different compartments, inlet(s) and outlet(s) may be located in various areas of the reaction containers (e.g., on the along the top portion 5021 and/or along the middle portion 5023).

A reaction container 5010 with compartments may be configured to have isolated sections where different reactions or processes may occur. In an example embodiment, the second, third and fourth compartments 5313, 5315, 5317 may be dedicated to mineralization reactions that may occur in the reaction container. The first compartment 5311 may be dedicated to collecting and passing some byproducts of CO2 mineralization such as Hydrochloric acid (HCl) and hydrobromic acid (HBr) from a reaction container to an adsorption cooling unit. The fifth compartment 5319 may contain an electrolyzer configured to process and capture other byproducts of CO2 mineralization.

According to one or more embodiments, one or more compartments of the reaction container 5010 may be removable. A removable compartment may be an isolated enclosed space, where the top wall of a removable compartment is connected to a bottom wall of an adjacent removable compartment. A removable compartment may be cylindrical in shape. Those skilled in the art would appreciate that various methods and components may be used to splice the removeable compartments of the reaction container together. According to one or more embodiments, hoop straps may be used to splice the removeable compartments of the reaction container. Hoop straps may be included on the exterior surface 5014 of the reaction container 5010 and may be vertically spaced.

A removable compartment may be fluidly decoupled from other compartments before removal. For example, the third compartment 5315 may be fluidly decoupled from the second compartment 5313 and fourth compartment 5317 and removed. Those having skill in the art will appreciate that valves fluidly coupling the compartments may be used to control the flow of fluid, or to stop the flow of fluid between compartments. A removed compartment may be modified and reinstalled into the reaction container 5010, or the removed compartment may be replaced with another compartment.

According to one or more embodiments, the removable compartments may have several shapes and may be made from several types of materials (materials are described below). In an example embodiment, the fifth compartment 5319 may be fabricated of damage-resistant and durable materials to prevent damage to the container when the fifth compartment 5319 rests on the surface 3025 or other support structure. The first compartment 5311 may be fabricated from similar materials as the fifth compartment; however, the second, third, and fourth compartments 5313, 5315, 5317 forming middle portion 5023 of the reaction container may be fabricated from inflatable material.

According to one or more embodiments, one or more shells may be inserted between the removable compartments. For example, a shell ring may be inserted between the second compartment 5313 and the third compartment 5315. Inserting a shell ring may be useful in adjusting the height of a reaction container 5010. A shell such as a shell ring may be cylindrical in shape, however those having skill in the art would appreciate that in one or more embodiments, a shell may other shapes. For example, a shell included between the fifth compartment 5319 the surface 3025 may have a u-shaped shell.

According to one or more embodiments, the dimensions of a reaction container with removable compartments may be about 4.0 meters in diameter and from about 4.0 meters to 6.0 meters in height. However, a reaction container with removable compartments may have greater height if additional removable compartments are added. For example, a sixth compartment (not shown) may be added below the fifth compartment 5319.

According to one or more embodiments, the entire reaction container 5010 or one or more compartments of a reaction container may be inflated or deflated. A reaction container 5010 may be inflated for use and deflated when stored or transported. A deflated reaction container may occupy less space than an inflated reaction container which is useful for storage and transportation. Air or other substances that are non-reactive with the reaction products may be used to inflate the reaction container.

A reaction container may be designed to withstand concentrations of reactive substances like acids and bases. In one or more embodiments, the reaction container may be fabricated from non-metallic and corrosion resistant materials or components. In one or more embodiments, the reaction container is fabricated from material including, but not limited to, carbon fiber, plastic, thermoplastics or rubber. The rubber material used to fabricate the reaction container may be Chloro-Sulfonated Polyethylene synthetic rubber (CSM). CSM is useful because it is substantially resistant to heat, oil, ozone, oxidizing agents, weathering, and tearing. In one or more embodiments the thermoplastic used to fabricate the reaction container may be Poly-Vinyl Chloride (PVC). PVC is useful because it is a good insulator with low moisture absorption. Further, PVC is substantially resistant to chemicals, corrosion, and flames. Further, both CSM and PVC are flexible therefore an inflatable reaction container and hoop straps may also be fabricated from CSM or PVC. Those having skill in the art would also appreciate that in one or more embodiments, the reaction container may contain some metallic components (e.g., stainless steel), such as sensors, valves, connection pieces, etc.

In some embodiments, multiple reaction containers 5010 may be used. Two or more reaction containers may be fluidly coupled together, such as in series or in parallel, for greater volumes of incoming fluid in one or more embodiments.

The reaction container 5010 may be reusable and may be transported (e.g., in a vertical or horizontal orientation) to another SCCS site after use. In one or more embodiments, the bottom portion 5025 of the reaction container may be configured to have wheels, which may allow easier transport of the reaction container.

According to embodiments of the present disclosure, reactants used for mineralization of CO2 may be provided inside the reaction container (e.g., in one or more compartments of a modularized reaction container or within the interior chamber of a reaction container without modularized compartments). For example, in some embodiments, as shown in FIG. 2, basaltic particles 5125 in a powder form may be placed in a cartridge inside the reaction container and released from the cartridge into the reaction container in a controlled manner. Other embodiments of introducing reactants into a reaction container are described in more detail below.

The reaction container 5010 may incorporate components for mixing reactants. In one or more embodiments, a recirculation pump may be used to stir the reactants. In one or more embodiments, the CO2 may be jetted into the interior chamber to stir fluids therein. In one or more embodiments, the reaction container 5010 may include a mixing system 5120, which includes a stir rod having a shaft and impeller, and a drive motor configured to rotate the shaft. In one or more embodiments, the reaction container may include an ultrasonic sonochemistry device 5170 configured to emit a high-power, low-frequency ultrasound or radio waves that mixes the contents of the reaction container. An ultrasonic sonochemistry device 5170 may be position inside or outside of the reaction container 5010 while operating to mix the contents of the reaction container. In some embodiments, each step for the CO2 mineralization reaction may be performed in a single reaction container. In some embodiments, different steps in a CO2 mineralization reaction may be performed in different compartments of a single reaction container. In other embodiments, one or more steps in a CO2 mineralization reaction may be performed in different reaction containers (e.g., fluids may be passed between a first reaction container where reactants are introduced together and a second reaction container where a separate mixing step is performed).

In one or more embodiments, the reaction container 5010 may be configured to operate at atmospheric pressure. For example, CO2 injected into a reaction container 5010 may be reacted in the reaction container under atmospheric pressure and at room temperature. In one or more embodiments, the reaction container 5010 may be configured to withstand a pressure greater than atmospheric pressure because it may receive pressurized CO2. The valves and flowlines receiving and distributing high pressure fluids to the reaction container are similarly configured to withstand high pressure.

In or more embodiments, the reaction container includes sensors including but not limited to, pressure sensor, temperature sensor, or a pH sensor.

According to one or more embodiments, the reaction container 5010 may include leak detectors 5190 configured to monitor and relay alerts about release of reactants and products into the environment, including CO2 and acids. FIG. 2 shows a leak detector located near the top of the reaction container; however, some leak detectors, including those made of membrane liners and drain pipes configured to detect liquids may be located near the bottom of the reaction container. Those having skill in the art will appreciate that several types of leak detectors may be used.

A reaction container may be configured to accommodate multiple reactions producing precipitates and other byproducts during CO2 mineralization. In one or more embodiments, the fluids flowing in and out of the reaction container may contain solid particles and gases. For example, the reaction container may receive substances such as CO2, H2O, nanoparticles, and metallic ions, via an inlet and distribute substances, such as mineralized precipitates, hydrochloric acid (HCl), H2, and O2 via an outlet.

In one or more embodiments, calcium chloride (CaCl2), magnesium chloride (MgCl2), calcium bromide (CaBr2), and magnesium bromide (MgBr2) are introduced into the interior chamber of the reaction with CO2 and H2O as reactants. The magnesium ions (Mg2+) and calcium ions (Ca2+) in solution react with CO2 and H2O to mineralize to form magnesite (MgCO3) and calcite (CaCO3). Calcite is a mineral consisting of calcium carbonate and is a major constituent of sedimentary rocks such as limestone. Similarly, magnesite is a mineral consisting of magnesium carbonate. The magnesium and calcium ions may also react with CO2 to form dolomite (CaMg(CO3)₂). Hydrochloric acid (HCl) and hydrobromic acid (HBr) may also be produced in the mineralization reactions and may be collected.

Examples of mineralization reactions that may occur in the reaction container

include, but are not limited to, those provided for in Equations 1-6:

calcite formation: CaCl₂+CO₂+H₂O→CaCO₃+2HCl (Equation 1);

magnesite formation: MgCl₂+CO₂+H₂O→MgCO₃+2HCl (Equation 2);

calcite formation: CaBr₂+CO₂+H₂O→CaCO₃+2HBr (Equation 3);

magnesite formation: MgBr₂+CO₂+H₂O→MgCO₃+2HCl (Equation 4);

dolomite formation: CaCl₂+MgCl₂+2CO₂+2H₂O→CaMg(CO₃)₂+4HCl (Equation 5);

and

dolomite formation: CaBr₂+MgBr₂+2CO₂+2H₂O→CaMg(CO₃)₂+4HBr (Equation 6).

Referring again to FIG. 2, in one or more embodiments, the reaction container may be configured to contain basaltic particles 5125. Basalt is a commonly appreciated to be a volcanic rock with less than about 52 weight percent (wt %) of silica (SiO2). Basalt is appreciated to be rich in iron and magnesium. Certain types of basalts, such as plagioclase, may be calcium rich. Calcium and magnesium are water-soluble and readily release calcium and magnesium cations in solution. The basaltic particles may be a source of calcium and magnesium ions used for reactions with CO2 to produce calcite, magnesite, and dolomite among other products.

Basaltic particles 5215 may refer to any particles that include basalt as a base component. The basaltic particles may include basalt from natural sources, such as volcanic rocks, and may include various types of basalt, such as, but not limited to, tholeiitic basalt, alkali basalt, high-alumina basalt, and boninite. The definition of basalt may be obtained by consulting various classification methods of volcanic rocks, such as by utilizing a quartz, alkali feldspar, plagioclase, and feldspathoid (QAPF) diagram.

In one or more embodiments, the basaltic particles may include basalt and other components, such as pulverized non-basalt rocks and minerals. In one or more embodiments, basaltic particles may contain basalt in an amount ranging from about 20 wt % to 60 wt %, such as a lower limit selected from any of 20 wt %, 25 wt %, 30 wt %, and 35 wt %, to an upper limit selected from any of 45 wt %, 50 wt %, 55 wt %, and 60 wt %, where any lower limit may be used in combination with any upper limit.

In one or more embodiments, the basaltic particles may be in a form of, but not limited to, nano-sized particles, chips and fibers. The shape of the basaltic particles may be spherical, cubic, cylindrical or any other regular or irregular shapes. In one or more embodiments, the basaltic particles may have a size ranging from about 1 nanometer (nm) to 20 millimeters (mm), such as a lower limit selected from any of 1 nm, 5 nm, 10 nm, 50 nm, and 100 nm to an upper limit selected from any of 0.5 μm, 1 μm, 10 μm, 100 μm, 1 mm, 2 mm, 5 mm, 10 mm and 20 mm, where any lower limit may be used in combination with any upper limit.

In one or more embodiments, the basaltic particles introduced to the reaction container may be incorporated into a base fluid. A base fluid containing basaltic particles may be referred to as a “basaltic base fluid”. The base fluid may be any type of a fluid that is suitable for dispersing the basaltic particles into the reaction container. The basaltic base fluid may be injected into the reaction container. In some embodiments, the basaltic base fluid may contain additional fluids or additives including but not limited to sodium carbonate, lithium carbonate, barium carbonate, potassium carbonate.

In one or more embodiments, the basaltic base fluid may contain basaltic particles in an amount ranging from about 20 wt % to 60 wt %, such as a lower limit selected from any of 20 wt %, 25 wt %, 30 wt %, and 35 wt %, to an upper limit selected from any of 45 wt %, 50 wt %, 55 wt %, and 60 wt %, where any lower limit may be used in combination with any upper limit.

In one or more embodiments, the basaltic particles may be incorporated into a coating fluid to form a coating composition and coated onto interior surface 5012 of the reaction container 5010. The coating on the interior surface 5012 of the reaction container 5010 may also be referred to as “basaltic base coat”. The basaltic base coat 5235 may be applied to a section of the interior surface, such as the middle portion 5023, or the entire interior surface. In embodiments having modularized reaction containers, one or more modularized compartments of the reaction container may be coated with a basaltic base coat. The coating composition may include basaltic particles, the coating fluid and may also include other components such as additives. In one or more embodiments, the coating fluid may include a resin, paint, or adhesive allowing the basaltic particles to be coated onto and sufficiently adhered to the interior surface of the reaction container.

In one or more embodiments, the basaltic base coat may be placed onto interior surface 5012 by various methods such as adhering the coating to the interior surface 5012 with an adhesive, spray coating, or brush or roller application. In one or more embodiments, the interior surface 5012 of the reaction container has features like grooves or indentations to help the secure a basaltic base coat or basaltic sheet. In some embodiments, a sheet including basaltic particles (e.g., basaltic particles held in a resin sheet) may be secured onto the interior surface 5012 of the reaction container 5010 mechanically by using securing means such as straps, mesh, or fasteners.

The interior surface 5012 of the reaction container 5010 may include reaction straps 5245 configured to secure basaltic particles. According to one or more embodiments, the reaction straps 5245 may be spaced starting at 0.5 meters from the bottom 5025 of the reaction container till 1.0 m from the top 5021 of the reaction containers. The reaction straps 5245 are configured to resist pressurized reactants and products such as acids and bases.

In one or more embodiments, the basaltic base coat may contain basaltic particles in an amount ranging from about 20 wt % to 60 wt %, such as a lower limit selected from any of 20 wt %, 25 wt %, 30 wt %, and 35 wt %, to an upper limit selected from any of 45 wt %, 50 wt %, 55 wt %, and 60 wt %, where any lower limit may be used in combination with any upper limit. According to one or more embodiments, the thickness of the basaltic base coat applied to the reaction container may range from about 50 mm to 100 mm, such as a lower limit selected from any of 50 mm, 60 mm and 70 mm to an upper limit selected from any of 80 mm, 90 mm and 100 mm, where any lower limit may be used in combination with any upper limit.

In one or more embodiments, the reaction container is configured to contain water as a source of calcium and magnesium ions. Several sources of water contain metal ions, including spring water or ground water; however, seawater and brine have greater concentrations of metal ions. The salt concentration in seawater (salinity) is about 35 ppt (parts per thousand) on average. Brine is water that is saturated with salt and has a salinity of 50 ppt (parts per thousand) or greater. Both seawater and brine contain compounds that produce magnesium and calcium ions useful for the reaction with CO2.

In one or more embodiments, the reaction container may contain basalt base fluid, a basaltic base coat, as well as ion containing water. In one or more embodiments, the reaction container may be sealed for some time for the reactions to occur.

As mentioned, HCl and HBr may be produced as byproducts of the mineralization reactions of CO2. The produced HBr and HCl has limited solubility in the solution may be in gas phase. For collection, HBr and HCl may pass from a reaction container to an adsorption cooling unit 5011 through a flowline connecting the reaction container to an adsorption cooling unit. The adsorption cooling unit 5011 may be fabricated from anti-corrosive materials. The adsorption cooling unit 5011 may include a thermally driven refrigeration system that may use refringent fluids to condense HBr and HCl.

In one or more embodiments, the products of CO2 mineralization, such as calcite, magnesite, and dolomite, may pass into a vessel called an electrolyzer (e.g., 3090 in FIG. 1). The electrolyzer may be configured to house an anode and a cathode. H2 may form at the cathode and O2 may form at the anode. In one or more embodiments, CaCO3 in an electrolyzer reacts with H2O to produce calcium hydroxide (Ca(OH)2), CO2, 02, and H2. In one or more embodiments, CaCO3 in an electrolyzer reacts with H2O and CO2 to produce calcium bicarbonate (Ca(HCO3)2), CO2, O2, and H2. In one or more embodiments, MgCO3 in an electrolyzer reacts with H2O to produce magnesium hydroxide (Mg(OH)2), CO2, O2, and H2. In one or more embodiments, MgCO3 in an electrolyzer, reacts with H2O and CO2 to produce magnesium bicarbonate (Mg(HCO3)2), CO2, O2, and H2. The byproducts of the reaction such as Ca(OH)2, Mg(OH)2, Ca(HCO3)2, and Mg(HCO3)2 may be removed from the electrolyzer and may be optionally diluted and stored in subsurface 3020 or surface 3025 locations. In one or more embodiments, the byproducts of the reaction may be stored in the same wellbore that was used in the fracking operations.

Examples of CaCO3 and MgCO3 reactions that may occur to produce H2 and O2 by electrolysis are provided in Equations 7-10:

CaCO₃+2H₂O+electricity→0.50₂+H₂+Ca(OH)₂+CO₂ (Equation 7);

CaCO₃+2H₂O+CO₂+electricity→0.50₂+H₂+Ca(HCO₃)₂+CO₂ (Equation 8);

MgCO₃+2H₂O+electricity→0.50₂+H₂+Ca(OH)₂+CO₂ (Equation 9);

and

MgCO₃+2H₂O+CO₂+electricity→0.50₂+H₂+Mg(HCO₃)₂+CO₂ (Equation 10).

In one or more embodiments, the adsorption cooling unit 5011 or the electrolyzer 3090 may be configured to use alternative sources of energy that may be solar energy. Using solar energy may decrease CO2 emissions further. Those having skill in the art would appreciate that various renewable energy sources may be used.

Method of Use

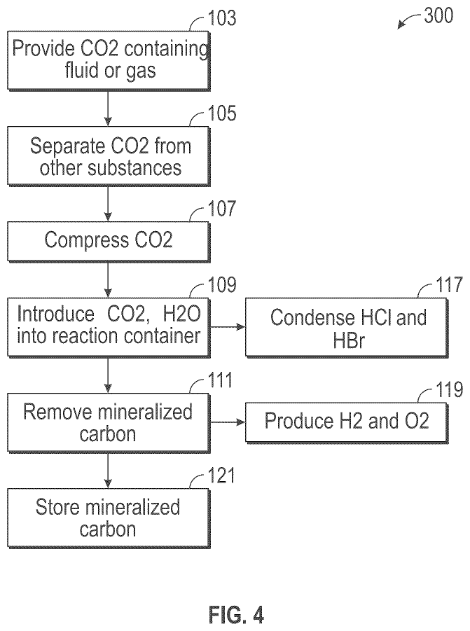

FIG. 4 is a flowchart that illustrates a method of SCCS in accordance with one or more embodiments.

In a method of SCCS 300 of FIG. 4, step 103 shows that CO2 containing fluid is provided according to one or more embodiments. CO2 may be captured and provided from several sources, including fracking operations, oil refineries, natural gas production process and other industrial sites, particularly those consuming fossil fuels. In one or more embodiments, the CO2 is provided after fracking operations by CO2 containing flowback fluid at a wellhead located at the surface as shown in FIG. 1.

In a method of SCCS of one or more embodiments, CO2 is separated from other substances, compounds, and impurities 105. The CO2 separation may occur at a treatment and separation facility where an H2O scrubber may be used to wash CO2 and remove less soluble gasses, such as hydrogen (H2), nitrogen (N2), and methane (CH4). Optionally, a separation membrane may also be used to separate CO2 from other light hydrocarbons. Membrane separation may use applied pressure to separate CO2 from other light hydrocarbons. In one or more embodiments, a portion of the flowback fluid may be flared.

In step 107, separated CO2 may be compressed. Compression may convert carbon dioxide liquid or gas into a critical or supercritical fluid. Critical and supercritical carbon dioxide dissolves in greater amounts than non-critical carbon dioxide; therefore, mixing water with carbon dioxide in the critical or supercritical state may help to increase the rate of reaction.

In a method of SCCS of one or more embodiments compressed CO2 is introduced into a reaction container for CO2 mineralization. In method 300 of FIG. 4, step 109 shows that a compressed CO2 fluid is introduced into a reaction container. In one or more embodiments, H2O is also introduced with the CO2. The H2O and CO2 may be introduced into the reaction container through a single flowline. In one or more embodiments, the H2O and the CO2 fluid are introduced into the reaction container though separate flowlines. In one more embodiment, H2O is introduced following introduction of CO2.

In one or more embodiments, basaltic base fluid containing basaltic particles is also added to the reaction container as a source of calcium and magnesium along with the H2O and CO2. In one or more embodiments, the basaltic base fluid is added to the reaction container before the H2O and CO2 is introduced.

In one or more embodiments, the reaction container may be coated with a coating containing basaltic particles. The basaltic base coat may be applied to a section of the reaction container or the entire interior surface of the reaction container may be coated. In one or more embodiments, the coating fluid may include a resin, paint, or adhesive allowing the basaltic particles to be coated onto and sufficiently adhered to the interior surface of the reaction container. In one or more embodiments, the basaltic base fluid is coated to the reaction container before the H2O and CO2 is introduced. In one or more embodiments, calcium and magnesium containing water, such as brine and seawater, may also be added to the reaction container.

In a method of SCCS of one or more embodiments, the reactants inside the reaction container may be mixed to increase the rate of reaction. In one or more embodiments, a recirculation pump may be used to stir the reactants. In one or more embodiments, the CO2 may be jetted to stir fluids. In one or more embodiments, the reactants are mixed with a stirring rod. In one or more embodiments, the reactants may be mixed using an ultrasonic sonochemistry device.

In one or more embodiments, the pressure, temperature, and pH value of the reactants and fluids in the reaction container may be monitored before, during, and/or after mineralization reactions.

In a method of SCCS of one or more embodiments, HCl and HBr may be produced as byproducts of the mineralization reactions of CO2. In one or more embodiments, the HBr and HCl may collect near the top of the reaction container and an outlet near the top of the reaction container may allow the HBr and HCl to pass to an adsorption cooling unit.

In FIG. 4, step 117 shows HBr and HCl removed from the reaction container may be condensed and collected by adsorption cooling. An adsorption cooling unit may use a thermally driven refrigeration system with refringent fluids to condense HBr and HCl. Refrigerant fluid, such as H2O, may be contained in a flow line that passes through a condenser chamber in the adsorption cooling unit. The condenser chamber may contain the gaseous HBr and HCl that condenses into a liquid upon contact with the cooler surface of the refrigerant containing flowline.

In one or more embodiments of FIG. 4, step 111 shows that products of CO2 mineralization may be removed from the reaction container. In one or more embodiments, products of mineralization may be stored in subsurface or surface locations, as shown in step 121. In one or more embodiments, products, such as calcite, magnesite, and dolomite, may be used to produce H2 and O2 by electrolysis, as shown in step 119. The H2 and O2 are produced at different electrodes. The H2 and O2 may be compressed in gas cylinders or tanks and stored for use. The H2 and O2 produced may be used in other industrial application, such as in refinery applications and for powering H2 or O2-based fuel cells.

After use at a particular site, a reaction container may be transported to another location for use. In some embodiments, the reaction container may be deflated during transportation.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed is:

1. A surface carbon capture and storage system, comprising:
a treatment and separation facility configured to receive a CO2 containing fluid and to extract CO2 from the CO2 containing fluid;
a compressor coupled downstream of the treatment and separation facility and configured to compress the extracted CO2 into a compressed CO2; and
a reaction container coupled downstream of the CO2 compressor configured to receive compressed CO2, water, and reactants.

2. The surface carbon capture and storage system of claim 1, wherein the surface carbon capture and storage system is coupled downstream of a fracking system, the fracking system comprising a wellbore traversing a subsurface injection formation, where the subsurface injection formation provides the CO2 containing fluid and is in fluid communication with the downstream treatment and separation facility.

3. The surface carbon capture and storage system of claim 1, wherein the treatment and separation facility includes a separation membrane configured to separate CO2 from other light hydrocarbons.

4. The surface carbon capture and storage system of claim 1, further comprising an electrolyzer, where the electrolyzer is configured to receive a byproduct of mineralization from the reaction container.

5. The surface carbon capture and storage system of claim 1, further comprising an absorption cooling unit, where the absorption cooling unit is configured to receive a byproduct of mineralization from the reaction container.

6. The surface carbon capture and storage system of claim 1, wherein the reaction container contains a fluid comprising basalt particles.

7. The surface carbon capture and storage system of claim 6, where the fluid contains basalt particles in a range from about 20 wt % to 60 wt %.

8. The surface carbon capture and storage system of claim 1, wherein the reaction container comprises a coating of basaltic particles.

9. The surface carbon capture and storage system of claim 1, wherein the reaction container includes a mixing system.

10. The surface carbon capture and storage system of claim 1, wherein the reaction container is fluidly coupled to at least one additional reaction container.

11. The surface carbon capture and storage system of claim 1, wherein the reaction container is inflatable.

12. The surface carbon capture and storage system of claim 1, wherein an interior surface of the reaction container includes separate compartments.

13. The surface carbon capture and storage system of claim 12, wherein the compartments of the reaction container are removable.

14. A method for surface carbon capture and storage, the method comprising:
separating CO2 from a CO2 containing fluid;
compressing the separated CO2;
introducing compressed CO2, water, and a reactant into a reaction container;
mineralizing CO2 in the reaction container;
outputting the mineralized CO2 from the reaction container; and
storing the mineralized CO2.

15. The method of claim 14 further comprising collecting the CO2 containing fluid from a fracking system.

16. The method of claim 14, where separating CO2 from the CO2 containing fluid utilizes a separation membrane.

17. The method of claim 14, where a basaltic particle fluid is also introduced into the reaction container prior to mineralizing CO2.

18. The method of claim 14, where a portion of an interior surface of the reaction container is coated with basaltic particles.

19. The method of claim 14, further comprising the step of passing a byproduct of the mineralization into an adsorption cooling unit.

20. The method of claim 14, further comprising the step of passing a byproduct of mineralization into an electrolyzer.
